(19) United States
(12) Patent Application Publication
(10) Pub. No.: US 2015/0254589 A1
(43) Pub. Date: Sep. 10, 2015

(54) System and Method to Provide Inventory Optimization in a Multi-Echelon Supply Chain Network

(71) Applicant: Tata Consultancy Services Limited, Maharashtra (IN)

(72) Inventors: Avneet Saxena, Karnataka (IN); Anil Kumar Gupta, Karnataka (IN)

(21) Appl. No.: 14/311,866

(22) Filed: Jun. 23, 2014

(30) Foreign Application Priority Data
Mar. 4, 2014 (IN) 735/MUM/2014

(51) Int. Cl. G06Q 10/06; G06Q 10/08

(52) U.S. Cl. CPC G06Q 10/06315; G06Q 10/087

(57) ABSTRACT

System(s) and method(s) to provide inventory optimization in a multi-echelon supply chain network are disclosed. An input data comprising one or more product supply parameters along with an uncertainty factor associated with the product supply parameters are received through a configurable user interface. The input data is used to create a multi-echelon supply chain network. Supplier nodes are selected based on optimizing parameters and are allocated with respect to demand nodes. A lead time demand and a safety stock parameter are calculated. An optimal inventory plan is generated for each supply chain member associated with the supply chain network along with the safety stock parameter by minimizing the uncertainty factor thereby providing the inventory optimization. The optimal inventory plan is displayed in one or more parameters over the configurable user interface.

### CROSS-REFERENCE TO RELATED APPLICATIONS AND PRIORITY

This U.S. patent application claims priority under 35 U.S.C. §119 to India Patent Application No. 735/MUM/2014, filed on Mar. 4, 2014. The aforementioned application is incorporated herein by reference in its entirety.

### TECHNICAL FIELD

The present disclosure in general relates to a method and system to provide inventory optimization. More particularly, the present disclosure relates to the inventory optimization in a multi-echelon supply chain network.

### BACKGROUND

With advancement in technology and diverse and varying customer demands, every company faces a challenge of matching a supply volume with respect to these diverse customer demands. The management of supply volume is directly proportional to profit that any company may have and thus badly affects the profitability of the company. The requirement of companies is too keep the inventory level low and sell the inventory as quickly as possible. Thus the concern that each company may have is to take decision regarding when and how to supply thereby maintaining a required or minimum level of inventory so as to attain maximum profitability.

One of the basic approaches to handle inventory targets involves setting of number of days of supply as a coverage target. Inventory calculations to meet the demand are performed by considering a single item to be supplied to a single location. Such approaches may be useful for single echelon however, may not give desired and beneficial results in multi-echelon environment where inventory levels are to be managed with respect to a particular supply chain and not just to the single location.

All classical and conventional inventory solutions are based on a number of assumptions that are usually not satisfied in practice. All these solutions consider constant demand over the period and one customer service level, but they do not or partially consider many practical and operational constraints like supply capacity, storage capacity, change in demand over the period, lead time variation, individual customer service levels. Due to this practical limitation, classical models fail to provide optimal inventory policy to make supply chain more lean and efficient. Moreover the traditional approaches do not give service level sensitivity analysis. Individual customer service level is another important characteristics missing in traditional solutions. Further, uncertainty in demand and lead time creates lot of challenges while estimating uncertain demand and supply during safety stock calculation.

Thus, a heretofore unaddressed need exists in the industry to address the aforementioned deficiencies and inadequacies.

### SUMMARY OF THE DISCLOSURE

This summary is provided to introduce aspects related to system(s) and method(s) to provide inventory optimization in a multi-echelon supply chain network and the aspects are further described below in the detailed description. This summary is not intended to identify essential features of the claimed subject matter nor is it intended for use in determining or limiting the scope of the claimed subject matter.

Embodiments of the present disclosure provide a system and method to provide inventory optimization in a supply chain network. Briefly described, in architecture, one embodiment of the system, among others, can be implemented as follows. The system includes a computerized, configurable user interface. A processor is in communication with the computerized, configurable user interface. A memory is coupled to the processor, wherein the processor is capable of executing a plurality of modules stored in the memory, and wherein the plurality of module comprise: a receiving module configured to receive an input data through the user interface, wherein the input data is used to create a multi-echelon supply chain network, and wherein the input data comprise at least one product supply parameter along with an uncertainty factor associated with the at least one product supply parameter; an allocation module configured to allocate at least one supplier node with respect to at least one demand node, wherein the at least one demand node is associated with the multi-echelon supply chain network, wherein the at least one supplier node is selected based on at least one optimizing parameter. A calculation module is configured to calculate a lead time demand from a source to a destination as per the multi-echelon supply chain network; and calculate a safety stock parameter based on the lead time demand by using a dynamic programming methodology along with an optimization technique, wherein the safety stock is calculated by considering the uncertainty factor. A generation module is configured to generate an optimal inventory plan for each supply chain member associated with the multi-echelon supply chain network along with the safety stock parameter for each product and each location associated with the multi-echelon supply chain network, wherein the optimal inventory plan is generated by minimizing the uncertainty factor, thereby providing inventory optimization, and wherein the optimal inventory plan is displayed in at least one format over the configurable user interface.

The present disclosure can also be viewed as providing methods to provide inventory optimization in a supply chain network. In this regard, one embodiment of such a method, among others, can be broadly summarized by the following steps: receiving an input data through a configurable user interface, wherein the input data is used to create a multi-echelon supply chain network, and wherein the input data comprise at least one product supply parameter along with an uncertainty factor associated with the at least one product supply parameter; allocating at least one supplier node with respect to at least one demand node, wherein the at least one demand node is associated with the multi-echelon supply chain network, wherein the at least supplier node is selected based on at least one optimizing parameter; calculating a lead time demand from a source to a destination as per the multi-echelon supply chain network; calculating a safety stock parameter based on the lead time demand by using a dynamic programming methodology along with an optimization technique, wherein the safety stock parameter is calculated by considering the uncertainty factor; and generating an optimal inventory plan for each supply chain member associated with the multi-echelon supply chain network along with the safety stock for each product and each location associated with the multi-echelon supply chain network, wherein the optimal inventory plan is generated by minimizing the uncertainty factor, thereby providing the inventory optimization, and wherein the optimal inventory plan is displayed in at least one format over the configurable user interface, wherein receiving the input data, allocating at least one supplier node, calculating the lead time demand, calculating the safety stock parameter and the generating the optimal inventory plan are performed by a processor of a computerized device.

The present disclosure can also be viewed as providing a non-transitory computer readable medium embodying a program executable in a computing device to provide inventory optimization in a supply chain network. Briefly described, in architecture, one embodiment of the program, among others, can be broadly summarized by the following program code: a program code for receiving an input data through a configurable user interface, wherein the input data is used to create a multi-echelon supply chain network, and wherein the input data comprise at least one product supply parameter along with an uncertainty factor associated with the at least one product supply parameter; a program code for allocating at least one supplier node with respect to at least one demand node, wherein the at least one demand node is associated with the multi-echelon supply chain network, wherein the at least supplier node is selected based on at least one optimizing parameter; a program code for calculating a lead time demand from a source to a destination as per the multi-echelon supply chain network; a program code for calculating a safety stock parameter based on the lead time demand by using a dynamic programming methodology along with an optimization technique, wherein the safety stock parameter is calculated by considering the uncertainty factor; and a program code for generating an optimal inventory plan for each supply chain member associated with the multi-echelon supply chain network along with the safety stock parameter for each product and each location associated with the multi-echelon supply chain network, wherein the optimal inventory plan is generated by minimizing the uncertainty factor, thereby providing inventory optimization, and wherein the optimal inventory plan is displayed in at least one format over the configurable user interface.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system to provide inventory optimization in multi-echelon supply chain network is shown, in accordance with an embodiment of the present subject matter.

FIG. 2 illustrates the system to provide inventory optimization in multi-echelon supply chain network, in accordance with an embodiment of the present subject matter.

FIG. 3 illustrates a method to provide inventory optimization in multi-echelon supply chain network, in accordance with an embodiment of the present subject matter.

FIG. 4 illustrates one or more exemplary results associated with an optimal inventory plan in accordance with an exemplary embodiment of the present subject matter.

FIGS. 5a and 5b illustrates retailer inventory planning in accordance with an exemplary embodiment of the present subject matter.

FIGS. 6a and 6b illustrates wholesaler inventory planning in accordance with an exemplary embodiment of the present subject matter.

FIGS. 7a and 7b illustrates Replenishment plan of distributors (RDC) in accordance with an exemplary embodiment of the present subject matter.

### DETAILED DESCRIPTION

While aspects of described system and method to provide inventory optimization in a multi-echelon supply chain network may be implemented in any number of different computing systems, environments, and/or configurations, the embodiments are described in the context of the following exemplary system.

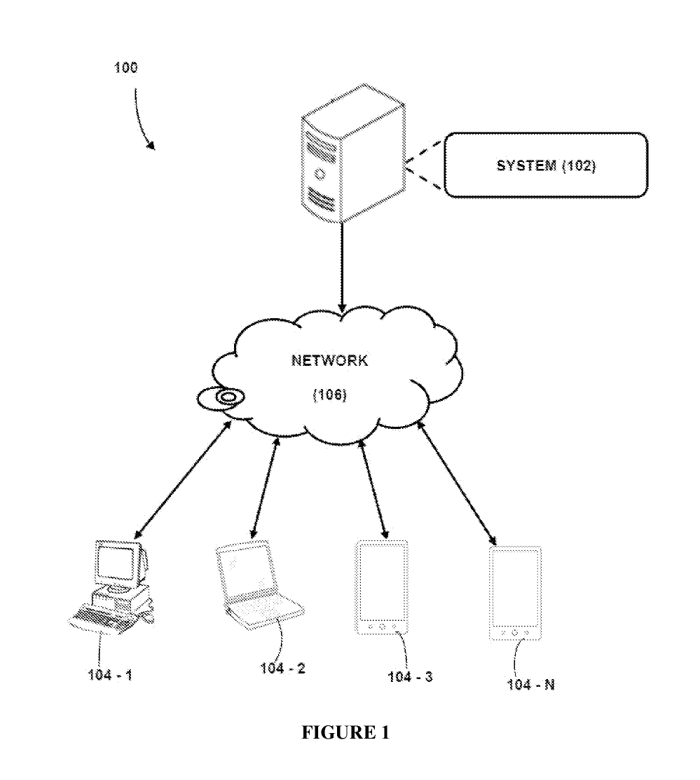

Referring now to FIG. 1, a network implementation 100 of system 102 to provide inventory optimization in a multi-echelon supply chain network has been illustrated. Input data is received through a configurable user interface to create a multi-echelon supply chain network. Allocating one or more supplier nodes with respect to one or more demand nodes associated with the supply chain network (multi-echelon supply chain network). Generating an optimal inventory plan for the supply chain network and one or more supply chain members (nodes). The optimal inventory plan is generated by calculating a lead time factor and a safety stock parameter. The optimal inventory plan is displayed in one or more formats through the configurable user interface.

Although the present subject matter is explained considering that the system 102 is implemented as an application on a server, it may be understood that the system 102 may also be implemented in a variety of computing systems, such as a laptop computer, a desktop computer, a notebook, a workstation, a server, a network server, and the like. In one implementation, the system 102 may be implemented in a cloud-based environment. It will be understood that the system 102 may be accessed by multiple users through one or more user devices 104-1, 104-2 . . . 104-N, collectively referred to as user 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

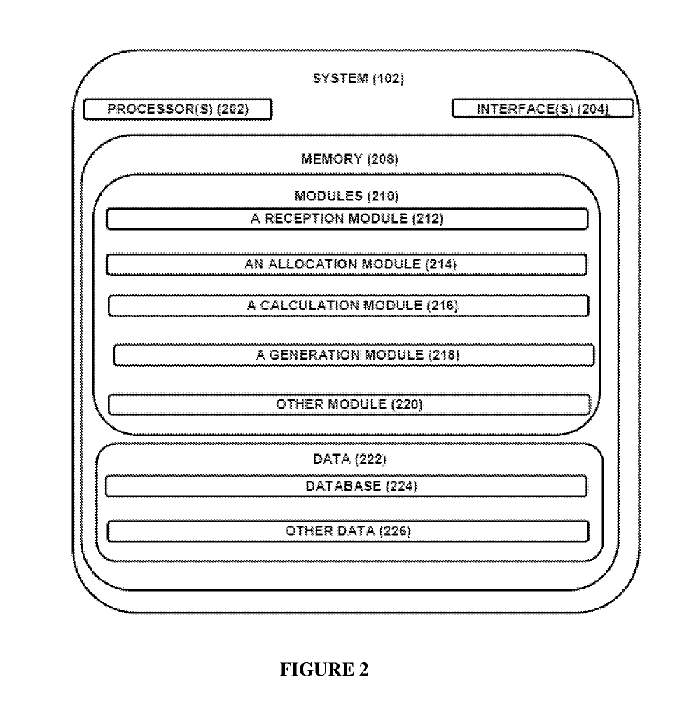

Referring now to FIG. 2, the system 102 is illustrated in accordance with an embodiment of the present subject matter. In one embodiment, the system 102 may include at least one processor 202, an input/output (I/O) interface 204 (herein a configurable user interface), a memory 208. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 208.

The I/O interface 204 may include a variety of software and hardware interfaces, for example, a web interface, a graphical user interface, and the like. The I/O interface 204 may allow the system 102 to interact with a user directly or through the client devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 208 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 208 may include modules 210 and data 212.

The modules 210 include routines, programs, objects, components, data structures, etc., which perform particular tasks, functions or implement particular abstract data types. In one implementation, the modules 210 may include a receiving module 212, an allocation module 214, a calculation module 216, a generation module 218 and other modules 220. Other modules 220 may include programs or coded instructions that supplement applications and functions of the system 102.

The data 222, amongst other things, serves as a repository for storing data processed, received, and generated by one or more of the modules 220. The data 222 may also include a database 224, and other data 226. The other data 226 may include data generated as a result of the execution of one or more modules in the other module 220.

The present disclosure relates to system(s) and method(s) to provide inventory optimization in a multi-echelon supply chain network. The inventory optimization is performed by generating an optimal inventory plan based on allocation of one or more supplier nodes with respect to one or more demand nodes. The one or more demand nodes are associated with the supply chain network (multi-echelon supply chain network). The system 102 identifies key challenges in managing inventory of supply chain from raw material suppliers to manufacturers and manufacturers to retailers with end objective of improvement of individual customer service level. The system 102 identifies real operational constraints at each of the supply chain in the supply chain network. The system 102 uses optimization techniques and methodology to address complex challenges faced in supply chain in order to optimize inventory and improve customer service level.

The receiving module 212 is configured to receive input data from one or more database along with one or more uncertainty factor from one or more user through the configurable user interface 204. The input data is stored in an efficient structure. The input data is used to create a supply chain network. The supply chain network comprises a multi-echelon supply chain network. The multi-echelon supply chain network comprises customers, retailers, warehouses, distribution centers, manufacturers, and suppliers.

The supply chain network is created in a predefined format. The format may include but is not limited to an excel sheet. The configurable user interface 204 may be configured or customized with respect to the format of the input data. The input data entered through the user interface 204 may be structured in one or more tables. The following tables may be created:
1. Build supply chain table: The build supply table contains all stages of the supply chain network and user option to select as their network. Fields of the build supply chain table may include but are not limited to Supply chain facility type, status, number of facility or a combination thereof.
2. Global Parameters Table: The global parameter table contains global parameters used in the system 102. The fields of the global parameter table may include but are not limited to Number of facilities, pre allocated supply network, Planning horizon, cost parameters like ordering cost, holding cost, transportation cost etc., or a combination thereof.
3. Demand table: The demand table contains demand information for each product at facility from where it is generated or forecasted. The fields of the demand table may include but are not limited to Facility name, period, product, demand or a combination thereof.
4. Distance Table: The distance table contains distance information between different source and destination location in the supply chain. Fields of the distance table may include but are not limited to Origin facility, Origin facility type, Destination Facility, Destination facility type, distance or a combination thereof
5. Parameters table: The parameters table contains different cost, capacity and other parameter for each facility. Fields in the Parameters table may include but are not limited to Facility, Facility type, Product, Ordering cost, Unit holding cost, Unit Backorder cost, Unit transportation cost, Unit production cost, Minimum capacity cost, maximum capacity, Initial inventory, Backorder allow, lead time or a combination thereof.
6. In transit inventory table: The in transit inventory table contains information for the previous order placed but not yet received. Fields of the in transit inventory table may include but are not limited to facility, facility type, period, product, previous order quality, or a combination thereof.
7. Service level table: The service level table contains information of individual service level for each demand centre from where demand originates. Fields of the service level table may include but are not limited to facility, service level, or a combination thereof.
8. Pre-allocation table: The pre-allocation table contains sourcing information for each facility as per pre allocation. Fields of the pre-allocation table may include but are not limited to destination type, destination facility, source type, source facility, allocation or a combination thereof.

The input data comprises demand data, facility related data, in transit inventory data, cost data and other parameters. The input data is imported in Statistical analysis system (SAS). The input data comprises a pre-processed input data in order to provide data to each of the supply chain.

The supply chain network comprises a multi-echelon supply chain network. The input data further comprises Build supply chain of the product, global parameters associated with the product, demand information for each product, Bill of Material (BOM), distance information between a source and a destination point in the supply chain network, cost parameters of the product, capacity parameters (for production, storage, rack, fleet etc) in transit inventory parameters, service level parameters, pre allocation parameters, or a combination thereof.

The uncertainty factor comprises uncertainty in demand, uncertainty in lead time, supplier constraints, by individual customer level or aggregate service level, or a combination thereof.

The product supply parameters further comprises forecast demand and the uncertainty factor further comprises standard deviation in forecast demand. As there may be variation in the forecast demand and actual sales, an extra inventory, herein referred to as a safety stock parameter needs to be planned and calculated for minimizing a risk demand and a lead time variation.

The allocation module 214 if configured to execute a Mixed Integer Linear Programming (MILP) methodology to optimally allocate one or more different demands nodes to one or more supplier nodes based on one or more optimizing parameters. The optimizing parameters comprise total transportation cost, ordering cost, inventory holding cost, distance, service level and facility storage capacity for the products. Suppliers are selected based on either predefined rules (for example, based on Supply capacity, product quality, lead time, cost and service level based on user preference) or pre allocated supply network (freezing suppliers or supply network partially or completely). After the demand nodes are allocated to the source nodes, a transportation lead time (stochastic lead time) is calculated from source to destination as per the supply chain network.

The calculation module 216 is configured to read demand, standard deviation of demand, lead time, and standard deviation of lead time.

The calculation module 216 is configured to calculate an average lead time using the dynamic programming approach. Following are the steps followed by the calculation module 216 to execute the dynamic programming approach:

a. Connect all possible node of supply chain from supplier to manufacturer and manufacturer to retailer or customers.
b. Get the lead time and transportation cost from each possible connection in supply chain
c. Determine the shortest path in the network in order to achieve minimum lead time, minimum transportation cost, or maximum service quality to improve supply chain efficiency and effectiveness.
d. Assign the right supplier to right demand node based on user preference like cost, lead time and service quality.
e. Calculate lead time as per assigned supplier.

Once lead time is calculated, safety stock parameter may be estimated by using flowing steps—

a. Iterate following steps from i=1 to T
i. Get the lead time L from source to demand center
ii. Read the demand from period i+1 to i+L and store it in an array
iii. Calculate the average demand from period i+1 to i+L and store it in solution Sᵢ

b. Store all the solution Sᵢ in an array of size T

The calculation module 216 is further configured to calculate the safety stock parameter based on the average lead time demand for each period dynamically using dynamic programming (in pre-processing) with uncertainty calculations (Standard deviation and mean of demand and lead time). Following steps are used to find optimal safety stock with replenishment planning (Integration of replenishment planning with safety stock for optimal solution):
a. Split problem P into sub problems P₁, P₂, . . . , P_{T} as given planning Horizon T
b. Iterate following steps from period i=1 to

If current inventory level>Average future demand during lead time then Calculate safety stock and do not place any extra order for safety stock. Store solution in Sᵢ

### Else

Calculate safety stock and place the new order or increase the order quantity for previous order placed. Store solution in Sᵢ
a. Combine solution (safety stock for each period) Sᵢ to determine the final safety stock plan with solution S.
b. Return the solution S.

The system 102 processes the input data to provide data for each supply stage replenishment planning The safety stock parameter calculated by the calculation module 216 is considered at each location and for each product.

The generation module 218 is further configured to generate an optimal inventory plan (replenishment plan) by using a mathematical model considering order lead time, initial and in transit inventory, supply capacity, storage capacity, minimum order quantity, single order for multiple products etc. The optimal inventory plan is generated by minimizing the uncertainty factor thereby providing the inventory optimization. The generation module 218 uses following steps for generating the replenishment plan:
Read the Ending on hand inventory of each product for each period
Get the safety stock value of each product for each period.
Check the condition
   IF (Ending on hand inventory (t)<Safety stock level (t))

Determine the previous period replenishment plan by adjusting order quantity for the order recently placed or place a new order depending on trade-off between extra ordering cost and holding cost to maintain safety stock level considering supply capacity and storage capacity.
ELSE
   Previous period replenishment plan remains unchanged

The final or output inventory optimization plan in terms of replenishment plan is generated by considering the safety stock parameter. The replenishment plan is generated to give a replenishment policy at a supplier level. The output replenishment plan (or replenishment plan) is then used to generate one or more KPI reports or graphs or a combination thereof.

The generation module 218 is further configured to use the optimal inventory plan to create and display the inventory optimization plan in one or more formats. The one or more formats may include one or more tables to produce the KPI reports and graphs. Following tables are created to generate KPI and reports:
1. Replenishment plan table: The replenishment plan table contains the replenishment plan (reorder point and order quantity for each product and each location). Informative Fields in the replenishment plan may include but are not limited to facility, facility type, product, period, replenishment quality, or a combination thereof
2. Inventory plan Table: The inventory plan table contains the inventory information for each period, product and facility location. Informative fields may include but are not limited to facility, facility type, product, period, Beginning on hand Inventory (BOH), Ending on hand inventory (EOH), Supply (received order quantity), demand or a combination thereof.
3. Demand satisfaction table: the demand satisfaction table contains satisfied and unsatisfied demand information for each period, product and facility location. Informative fields may include but are not limited to facility, facility type, product, period, demand, demand fulfilled, unsatisfied demand, or a combination thereof
4. Cost summary table: The cost summary table contains cost summary information for each facility location. Informative fields may include facility, facility type, total ordering cost, total holding cost, total transportation cost, total production cost, or a combination thereof.
5. Order satisfaction table: The order satisfaction table contains the satisfied and unsatisfied order information for each product and facility location. Informative fields may include but are not limited to facility, facility type, product, number of orders placed, number of orders fulfilled completely, or a combination thereof.
6. Fill rate table: The fill rate table contains KPI “Fill Rate” information for each product and facility location. The informative fields may include but are not limited to facility, facility type, product, fill rate (percentage of order satisfied), or a combination thereof.
7. Output service level table: The output service level table contains KPI “Service Level” information for each product and facility location. The informative fields may include but are not limited to facility, facility type, product, output service level (percentage of demand satisfied), or a combination thereof.
8. Inventory turnover table: The inventory turnover table contains KPI “Inventory Turn Over” information for each product and facility location. The informative fields may include but are not limited to facility, facility type, product, Inventory Turn Over (Inventory turnover ratio shows how many times your inventory is being turned over per year or planning horizon), or a combination thereof. The inventory turnover=total sales per year/average inventory,
9. Inventory in days table: The inventory in days table contains KPI “Inventory in Days” information for each product and facility location. Informative fields may include but are not limited to facility, facility type, product, inventory in days (how many days it will take to convert inventory into actual sale), or a combination thereof. The inventory in days=365/inventory turnover.

The inventory optimization pans are displayed in one or more format over the configurable user interface 204. The configurable user interface 204 is configured by using advance technology and filtering in java to perform different output analysis and creation of graphs.

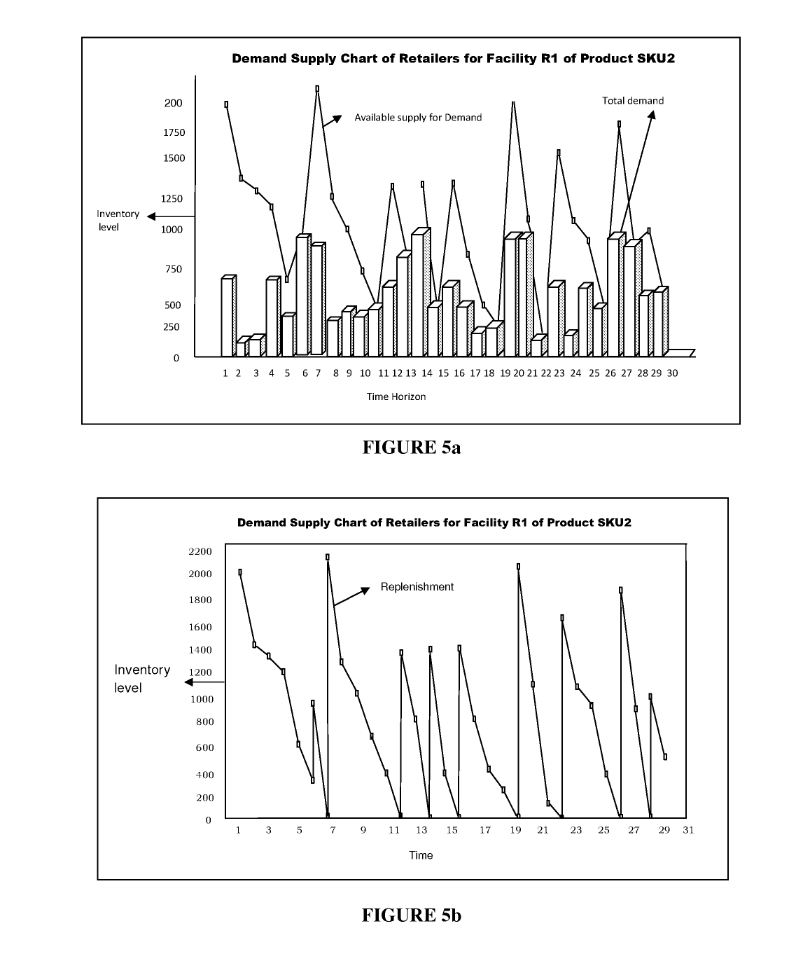

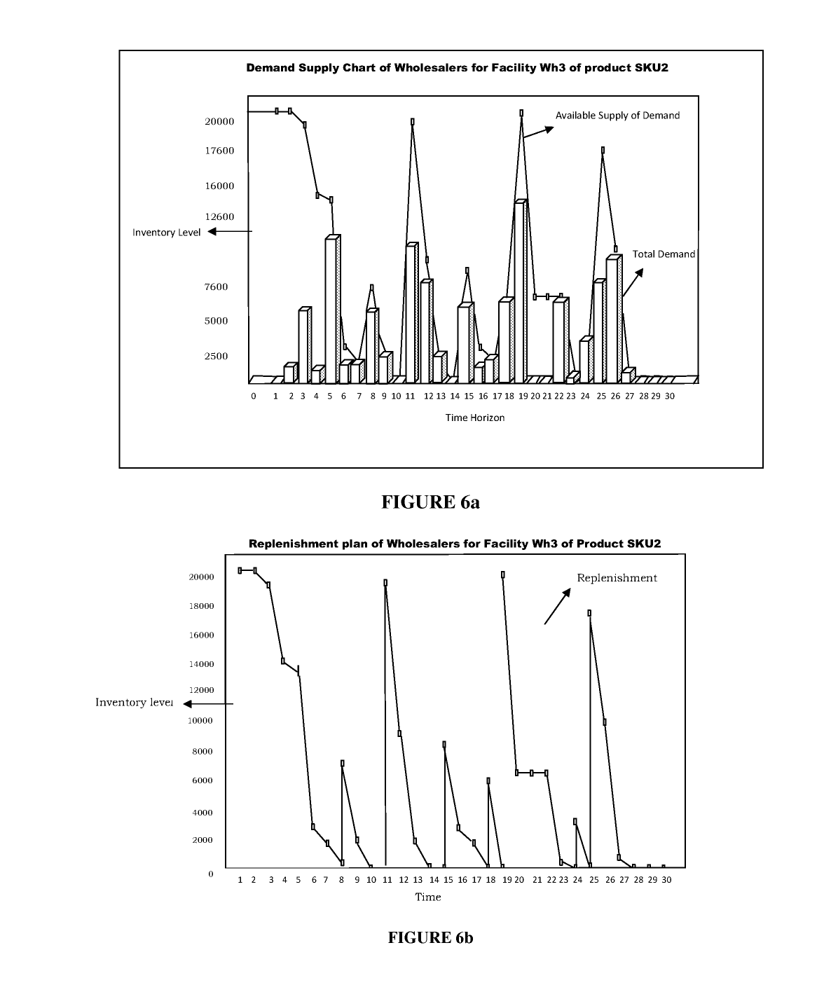

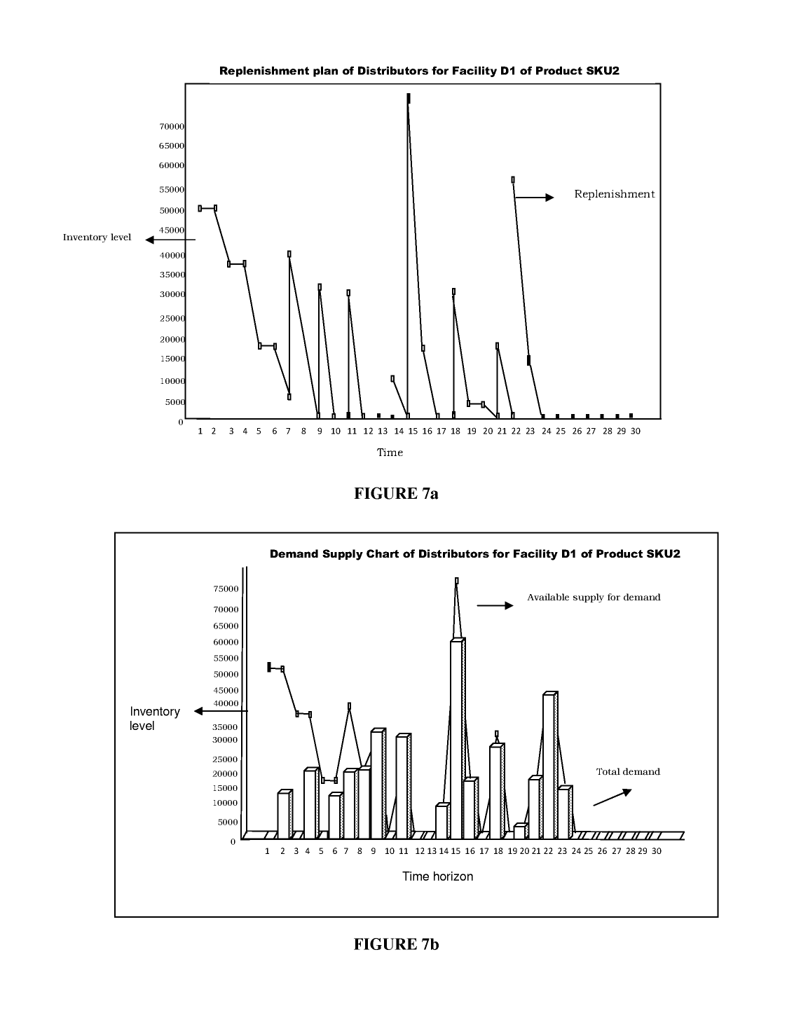

Referring to FIGS. 5a and 5b, Demand supply chart of retailers for facility R1 of product SKU 2 (Stock Keeping Unit 2) and replenishment plan of retailers for facility R1 of product SKU 2 is shown respectively. FIGS. 6a and 6b illustrates Demand supply chart for wholesalers for facility Wh3 of product SKU 2 and replenishment plan of wholesalers for facility Wh3 of product SKU 2 respectively. FIGS. 7a and 7b illustrates Replenishment plan of distribution for facility D1 of product SKU 2 and Demand supply chart of distributors for facility D1 of product SKU 2 respectively.

By way of a non limiting exemplary embodiment, the system 102 performs the inventory optimization by using the mixed integer programming methodology. The execution of the mixed integer programming methodology for an entire supply chain is discussed below:

In the first step, one or more decision variables are identified and used during processing of the input data. The decision variables may include but are not limited to Reorder Point for each product and each location, Reorder Quantity for each product and each location, Beginning on Hand and Ending on Hand Inventory for each product and each location, or a combination thereof.

In the second step, objective is set based on the decision variables. The objective is set to minimize the total cost which involves one or more components. The one or more components comprises ordering cost, inventory holding cost, transportation cost, stock out cost, back order cost, or a combination thereof.

In the third step, one or more constraints associated with the input parameters are identified. The constraints that are considered while generating output results may include but are not limited to Demand Satisfaction for each customer with individual service level, Storage capacity at each facility, Maximum supply capacity, Single Sourcing Allocation, Inventory Flow Balance for each period at each location and each product, Initial on hand and In transit inventory constraint, Minimum Order Quantity, Single order for multiple SKUs, Maximum transportation capacity for a lane, Predefined facility allocation, or combination thereof.

By way of another non limiting exemplary embodiment, the details of mixed integer programming methodology are explained below:

It is assumed that following are the sets prepared from the supply chain network:

Sets (refers to one or more entities (such as Retailers, warehouses) with similar such one or more entity such Retailers (R1 to Rn) etc
1=1 . . . R represents Retailers
p=1 . . . P represents Products
t=1 . . . T represents time periods

Following are the Parameters/Input Data:
I(0)_{i,p} is the Initial Inventory of Retailer i and product p
L is the Lead Time for replenishment
OCᵢ is ordering Cost of Retailer i
HC_{i,p} is Holding or Carrying Cost per unit of product p for Retailer i
TC Transportation Cost per unit distance and per unit Quantity
SOC is Stockout Penalty Cost per unit
SOC₁ is Stockout Penalty Cost per order
D_{i,p,t} is the i^{th} Retailer Demand for product p at period t
Disᵢ is the Distance between the Retailer i from its Source

Smaxₚ is the supplier Capacity for product p
S_{i,p,t} is the Supply received for Retailer i, product p at period t from previous orders/(Intransit Shipments)
SLᵢ is the Service level of ith Retailer (min % of received orders to be met for each Retailer)
   NumORDᵢ is number of Orders Received by Retailer i

Following are identified as Decision Variables:

Z_{i,t} is 1 if ordere is placed for Retailer i and time period t; 0 otherwise
Q_{i,p,t} is the Qty ordered at time for Retailer i and product p at timeperiod t
I_{i,p,t} is the beginning on hand of Retailer i, product p at time period t
DF_{i,p,t} is the i^{th} Retailers fraction of Demand Satisfied for product p at period t
CDF_{i,p,t} is 1 if i^{th} Retailers Demand is completely Satisfied for product p at period t; 0 otherwise

Following is set as the Objective Function:

### Minimize Z=Holding Cost+Ordering Cost+Stock out Cost+Transportation Cost

$$Minimize z = {\sum }_{i = 1}^{K} {\sum }_{p = 1}^{p} {\sum }_{t = 1}^{T} {l}_{i , p , t} * {HC}_{i , j} + {\sum }_{i = 1}^{K} {\sum }_{t = 1}^{T} {Z}_{i , t} * {OC}_{i} + {\sum }_{i = 1}^{R} {\sum }_{p = 1}^{P} {\sum }_{t = 1}^{T} {D}_{i , p , t} * ( 1 - {DF}_{i , p , t} ) * S O C + {\sum }_{i = 1}^{R} {\sum }_{p = 1}^{P} {\sum }_{t = 1}^{T} ( 1 - C D {F}_{i , p , t} ) * S O {C}_{1} + {\sum }_{i = 1}^{R} {\sum }_{p = 1}^{P} {\sum }_{t = 1}^{T} {Dis}_{i} * {Q}_{i , p , t} * TC$$

Following are Subject to (constraints):

### I_{i,p,1}=I(0)_{i,p} Inventory/Stock Constraint

I_{i,p,t+1}=I_{i,p,t}+S_{i,p,t}−D_{i,p,t}*DF_{i,p,t} ∀i,p,t=1 to LSupply Flow Balance Constraint
I_{i,p,t+1}=I_{i,p,t}+Q_{i,p,t-L}−D_{i,p,t}*DF_{i,p,t} ∀i,p,t=L+1 to T−1 Order Flow Balance Constraint
I_{i,p,T}+Q_{i,p,T-L}≧D_{i,p,T}*DF_{i,p,T} ∀ i,pEnding Period Inventory Constraint
Q_{i,p,t}≧O_{i,p,t}*Cmin_{i,p} ∀ i, p, tMinimum Order Constraint
I_{i,p,t}+Q_{i,p,t-L}≦Cmax_{i,p} ∀ i, p, tMaximum Capacity Constraint
Σᵢ₌₁^{R}Q_{i,p,t}≦Smaxₚ ∀ i, p, tSupplier Capacity Constraint
DF_{i,p,t}≦1 Demand Satisfaction Variable constraint
M*O_{i,p,t}−Q_{i,p,t}≧0 Order Placement constraint
Σₚ₌₁^{p} O_{i,p,t}≦P*Z_{i,t} Single Order constraint

### DF_{i,p,t}−CDF_{i,p,t}≧0 Complete Order Variable Constraint

Σₜ₌₁^{T}Σₚ₌₁^{p}CDF_{i,p,t}≧NumORDᵢ*SLᵢ/100 ∀ iCustomer Service Level Constraint

The system 102 provides a fusion of SAS platform with java technology using advance optimization techniques (such as Mixed integer programming, dynamic programming approach, Greedy Search heuristic methodology, etc.).

The configurable user interface 204 is configured in such a manner so as to provide flexibility in accepting input data and displaying output results in various formats by using advance swing components of java. The advance swing components of java follow a Model-view-controller paradigm (MVC) to provide the flexibility to the configurable user interface 204. The Swing components may change their appearance based on the current “look and feel” library. The configurable user interface 204 further comprises excel based filter to filter the input data whenever required in order to improve the processing of the data for generating optimization results. The input data may be exported or imported through the configurable user interface 204 by utilizing the swing components. The configurable user interface 204 may also be integrated with any external software by using the swing components that makes the configurable user interface a swing interface.

System 102 supports flexible scenario and integrated scenario development for end user. The flexible scenarios include but are not limited to percentage change in demand, service level, lead time, capacity, preference to supplier selection, SC configuration, system level feasibility check, etc. Integrated scenario are based on dynamic supplier selection, replenishment plan, Inventory optimization based on safety stock which is equal to improved customer focused system 102.

The system 102 uses a multi threading technique for parallel processing of the input data in order to optimize the inventory for multi-echelon supply chain network.

The system 102 provides advantages by generating output in terms of inventory level at each facility, inventory replenishment plan for each facility production plan for each plant, output customer service level and high level cost summary such as inventory holding cost, production cost and order cost. This is further to be understood by a person ordinarily skilled in the art that such output is exemplary and is not restricting the scope of the present disclosure.

The details of the system 102 are explained by way of a non limiting exemplary embodiment. This is to be assumed that the system 102 receives that input data that refers to next 30 weeks demand for 6 customers and 1 warehouse. Customer service level is 95% and order lead time is 2 week. Warehouse has initial inventory 1000 and orders which are pending to receive for last 2 weeks are 150 and 200 respectively. Ordering cost is $2000 per order and holding cost per unit per week is $2. Unit production cost and production capacity of the plant over the period are given in input data. The system 102 assists a warehouse manager who wants to decide that how much inventory should he keep, when to order and how much to order to plant for replenishment?

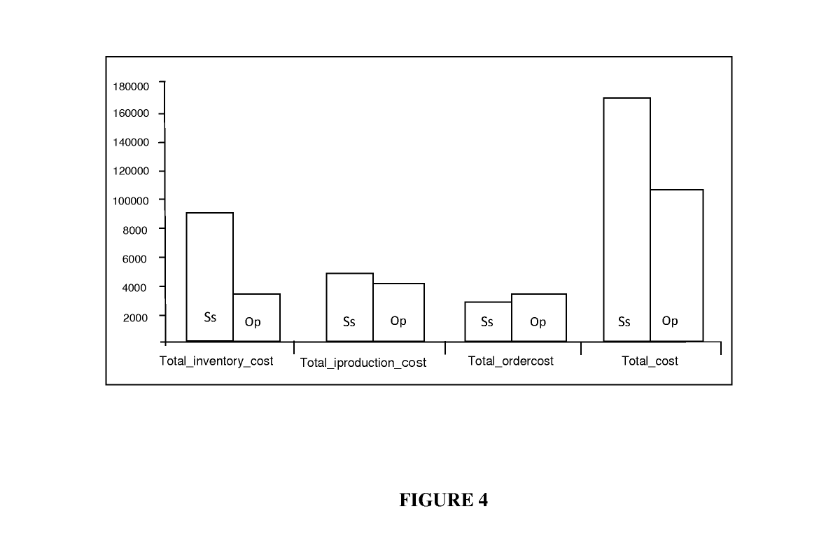

By way of a non limiting example, based on the above input data, the system 102 uses mixed integer programming methodology with the objective to minimize total cost and satisfy all above listed constraints. The input data is processed by implementation through the SAS OR. This is further to be understood by a person ordinarily skilled in the art, that below disclosed values are mere an exemplary comparison for which the intent is not to limit the scope of the disclosure and disclosure may provide variable results based on input data so processed. Referring to FIG. 4, following output results are generated and shown in table 1:

TABLE 1

| Policy | Ss (Max, Min) Policy | Optimal | Change |
|---|---|---|---|
| Total_inventory_cost | 94,086 | 33,942 | 63.92% |
| Total_production_cost | 47,640 | 40,812 | 14.33% |
| Total_ordercost | 28000 | 32000 | −14.29% |
| Total_cost | 169,726 | 106,754 | 37.10% |

The calculation module 216 is configured to calculate an optimal safety stock for each period by applying a dynamic programming method while considering the average lead time demand and standard deviation of demand during the given average lead time with standard deviation. The average demand for next following lead time periods are calculated dynamically towards the safety stock calculation. An advance heuristic algorithm has been applied to estimate optimal safety stock for each product and each location in pre-processing steps. By applying the Dynamic Programming method, lead time from supplier to customer is estimated by building supply chain network and for identifying below mentioned conditions:

a. Shortest lead time and minimum lead time variation. Based on identification this condition the dynamic algorithm is applied to calculate lead time for entire supply network. The lead time for entire supply network is used to calculate one lead time of entire network to distribute the goods to customer with I time instead of different LT of each supplier. This may be considered as a pre-processing for safety stock calculation.

The output safety stock of this algorithm is taken as input in Inventory optimization for further planning for replenishment for forecasted demand for each product at each location.

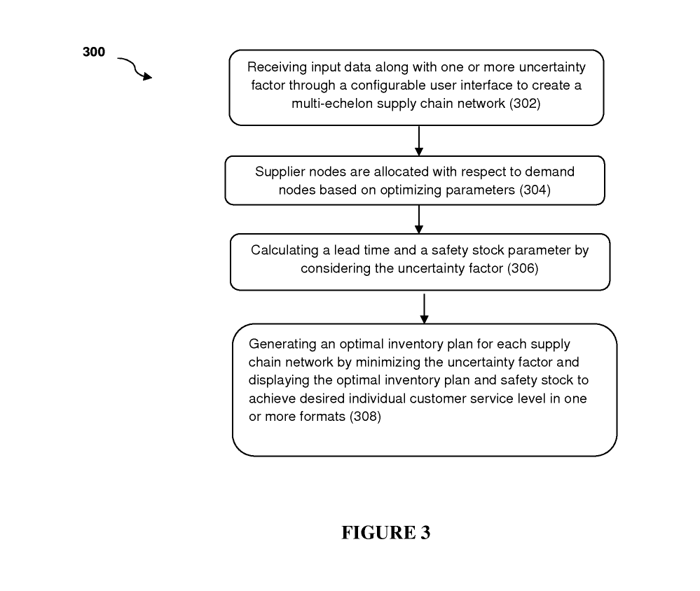

Referring to FIG. 3, the order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method can be implemented in any suitable hardware, software, firmware, or combination thereof. However, for ease of explanation, in the embodiments described below, the method 300 may be considered to be implemented in the above described system 102.

At block 302, input data is received along with one or more uncertainty factor through a configurable user interface to create a supply chain network.

At block 304, one or more supplier nodes are allocated with respect to one or more demand nodes based on one or more optimizing parameters.

At block 306, calculating a lead time demand and a safety stock parameter with respect to the uncertainty in demand and lead time.

At block 308, an optimal inventory plan is generated for each supply chain member in a supply chain network thereby minimizing the uncertainty factor and providing the inventory optimization. The optimal inventory plan is displayed in one or more formats over the configurable user interface.

The present system 102 and method is associated with variety of advantages. The system and method helps in reducing chances of obtaining local optimum using mathematical modeling for inventory optimization for multi echelon (end to end supply chain, global optimization). The system and method improve solution applicability by creating a system encompasses supplier dynamics and demand uncertainty based safety stock. This helps in calculating right inventory at each echelon without any duplicate calculation. The system and method provides optimal, effective, flexible and quick solution. The system uses mathematical model application to consider all important constraint to optimize cost, time and individual service level. The system and method can facilitate strategic, technical and operational problems and will lead to following improvements in multi echelon inventory optimization, replenishment, supplier dynamics and right safety stock decisions under uncertainty.
Right Individual customer service level can be obtained
Minimizing overall supply chain cost
Helps in Improvement in service level(Overall and individual customer service level)
Dynamic supplier selection of achieving best service levels
Minimizing inventory
Optimized Replenishment Plan for each supply chain member
Decision Scenario analysis with individual aforesaid improvements or combination of all.
Support sensitivity analysis
Support supply chain network configuration based on preferred predefined parameters or use of automated rules,

The system and method provides a dynamic supplier selection to improve the service level. The dynamic supplier selection is of two types, first is pre-defined user based supplier selection and second is by using a Greedy search algorithm. The Greedy search algorithm is applied for dynamic supplier selection by considering cost and demand. The capacity and lead time of distribution is used to decide each supplier for each demand node in network. This provides quick, efficient and flexible solution (supplier selection) as number of iterations may be controlled.

The system 102 and method also considers an individual service level for each customer to decide customer satisfaction and help in minimizing overall inventory in supply chain network. The system and method also minimizes demand and lead time uncertainty. The system and method provides replenishment planning and also optimize inventory at each echelon in the multi-echelon supply chain network.

The written description describes the subject matter herein to enable any person skilled in the art to make and use the embodiments of the disclosure. The scope of the subject matter embodiments are defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

We claim:

1. A method to provide inventory optimization in a supply chain network, the method comprising:
receiving an input data through a configurable user interface, wherein the input data is used to create a multi-echelon supply chain network, and wherein the input data comprise at least one product supply parameter along with an uncertainty factor associated with the at least one product supply parameter;
allocating at least one supplier node with respect to at least one demand node, wherein the at least one demand node is associated with the multi-echelon supply chain network, wherein the at least supplier node is selected based on at least one optimizing parameter;
calculating a lead time demand from a source to a destination as per the multi-echelon supply chain network;
calculating a safety stock parameter based on the lead time demand by using a dynamic programming methodology along with an optimization technique, wherein the safety stock parameter is calculated by considering the uncertainty factor; and
generating an optimal inventory plan for each supply chain member associated with the multi-echelon supply chain network along with the safety stock for each product and each location associated with the multi-echelon supply chain network, wherein the optimal inventory plan is generated by minimizing the uncertainty factor, thereby providing the inventory optimization, and wherein the optimal inventory plan is displayed in at least one format over the configurable user interface, wherein receiving the input data, allocating at least one supplier node, calculating the lead time demand, calculating the safety stock parameter and the generating the optimal inventory plan are performed by a processor of a computerized device.

2. The method of claim 1, wherein the multi-echelon supply chain network comprises customers, retailers, warehouses, distribution centers, manufacturers, and suppliers.

3. The method of claim 1, wherein the input data comprises at least one of: build supply chain of the product, global parameters associated with the product, demand information for each product, a bill of material (BOM), distance information between a source point and a destination point in the multi-echelon supply chain network, cost parameters of the product, capacity parameters of the product, in transit inventory parameters, service level parameters, and pre allocation parameters.

4. The method of claim 1, wherein the uncertainty factor further comprises at least one of: uncertainty in demand, uncertainty in lead time, supplier constraints, uncertainty by individual customer level, and uncertainty by aggregate service level.

5. The method of claim 1, wherein the at least one optimizing parameter further comprises at least one of: transportation cost, ordering cost, inventory holding cost, and distance and a facility capacity of the product.

6. The method of claim 1, wherein the optimal inventory plan is generated by applying a mixed integer programming approach over the input data.

7. The method of claim 1, wherein the method further comprising:
reading at least one of a demand, a standard deviation of the demand, a lead time, and a standard deviation of the lead time associated with the input data;
executing a mixed integer programming approach over the at least one of the demand, the standard deviation of the demand, the lead time, and the standard deviation of the lead time; and
generating the optimal inventory plan.

8. The method of claim 1, wherein the safety stock parameter is calculated by using a dynamic programming, and the at least one supplier node selection is done at each stage of a supply chain by using the optimization technique, wherein the optimization technique comprises a greedy search algorithm.

9. The method of claim 1, wherein the at least one format of the optimal inventory plan comprises at least one of: a replenishment plan table, an inventory table, a demand satisfaction table, a cost summary table, an order satisfaction table, a fill rate table, an output service level table, an inventory turnover table, and an inventory in days table.

10. The method of claim 9, wherein the replenishment plan table associated with the optimal inventory plan is modified with respect to the safety stock parameter.

11. The method of claim 9, wherein the replenishment plan table provides an order quantity for each product and each location with respect to the multi-echelon supply chain network.

12. The method of claim 1, wherein the inventory optimization plan is used to generate Key Point Indicator (KPI) reports and graphs with respect to product demand and supply for the multi-echelon supply chain network.

13. A system to provide inventory optimization in a supply chain network, the system comprising:
a computerized, configurable user interface;
a processor in communication with the computerized, configurable user interface; and
a memory coupled to the processor, wherein the processor is capable of executing a plurality of modules stored in the memory, and wherein the plurality of module comprise:
a receiving module configured to receive an input data through the user interface, wherein the input data is used to create a multi-echelon supply chain network, and wherein the input data comprise at least one product supply parameter along with an uncertainty factor associated with the at least one product supply parameter;
an allocation module configured to allocate at least one supplier node with respect to at least one demand node, wherein the at least one demand node is associated with the multi-echelon supply chain network, wherein the at least one supplier node is selected based on at least one optimizing parameter;
a calculation module configured to:
calculate a lead time demand from a source to a destination as per the multi-echelon supply chain network;
calculate a safety stock parameter based on the lead time demand by using a dynamic programming methodology along with an optimization technique, wherein the safety stock is calculated by considering the uncertainty factor; and
a generation module configured to generate an optimal inventory plan for each supply chain member associated with the multi-echelon supply chain network along with the safety stock parameter for each product and each location associated with the multi-echelon supply chain network, wherein the optimal inventory plan is generated by minimizing the uncertainty factor, thereby providing inventory optimization, and wherein the optimal inventory plan is displayed in at least one format over the configurable user interface.

14. The system of claim 13, wherein the optimal inventory plan is generated by applying a mixed integer programming approach over the input data.

15. The system of claim 13, wherein the calculation module is configured to:
read at least one of a demand, a standard deviation of the demand, a lead time, and a standard deviation of the lead time associated with the input data; and
execute a mixed linear programming approach over the at least one of the demand, the standard deviation of the demand, the lead time and the standard deviation of the lead time.

16. The system of claim 13, wherein the safety stock parameter is calculated by using a dynamic programming and the at least one supplier node selection is done at each stage of a supply chain by using the optimization technique, wherein the optimization technique comprises a greedy search algorithm.

17. The system of claim 13, wherein the generation module is configured to generate Key Point Indicator (KPI) reports and graphs with respect to product demand and supply for the multi-echelon supply chain network.

18. The system of claim 13, wherein the configurable user interface is configured by using advance technology and filtering logic in java, wherein the configurable user interface is further configured to receive data in at least one format from at least one user, and wherein the java is used with advance technology swing components for the configurable user interface to follow a Model View Controller Paradigm (MVC) in order to create a flexibility in the configurable user interface.

19. The system of claim 13, wherein the input data is processed by using a Statistical Analysis System (SAS) platform with java technology.

20. A non-transitory computer readable medium embodying a program executable in a computing device to provide inventory optimization in a supply chain network, the program comprising:
a program code for receiving an input data through a configurable user interface, wherein the input data is used to create a multi-echelon supply chain network, and wherein the input data comprise at least one product supply parameter along with an uncertainty factor associated with the at least one product supply parameter;
a program code for allocating at least one supplier node with respect to at least one demand node, wherein the at least one demand node is associated with the multi-echelon supply chain network, wherein the at least supplier node is selected based on at least one optimizing parameter;
a program code for calculating a lead time demand from a source to a destination as per the multi-echelon supply chain network;
a program code for calculating a safety stock parameter based on the lead time demand by using a dynamic programming methodology along with an optimization technique, wherein the safety stock parameter is calculated by considering the uncertainty factor; and
a program code for generating an optimal inventory plan for each supply chain member associated with the multi-echelon supply chain network along with the safety stock parameter for each product and each location associated with the multi-echelon supply chain network, wherein the optimal inventory plan is generated by minimizing the uncertainty factor, thereby providing inventory optimization, and wherein the optimal inventory plan is displayed in at least one format over the configurable user interface.
